(19) United States
(12) Patent Application Publication
(10) Pub. No.: US 2012/0209909 A1
(43) Pub. Date: Aug. 16, 2012

(54) CLOUD ACCESS SYSTEM AND OPERATING METHOD THEREOF

(75) Inventors: CHIH-YUAN HUANG, Tu-Cheng (TW); CHIEN-PAN LAI, Tu-Cheng (TW)

(73) Assignee: HON HAI PRECISION INDUSTRY CO., LTD., Tu-Cheng (TW)

(21) Appl. No.: 13/052,129

(22) Filed: Mar. 21, 2011

(30) Foreign Application Priority Data
Feb. 15, 2011 (CN) 201110038411.6

(51) Int. Cl. G06F 15/16

(52) U.S. Cl. 709/204

(57) ABSTRACT

A method for displaying data objects based on social networks is executed by a cloud access system. The method comprises receiving view preference settings from a user of the cloud access system. The view preferences settings comprise group names and time periods. The method further comprises querying a friend list according to the group and polling data objects shared by the user and the friends according to the time period. Each of the shared data objects is renamed to its uploaded time, re-sorted according to the timeline and stored in memory. The polling cycle is determined according to degrees of activities of the user and the friends on social networking sites.

### BACKGROUND

1. Technical Field

The present disclosure relates to cloud storage, and more particularly, to a cloud access system and operating method thereof.

2. Description of Related Art

Cloud storage is widely used, for example by social networking sites allowing sharing and download of data objects, such as documents, photos, and videos. However, conventional cloud access solutions allow authorized users to access only their accounts and provide no support for data objects shared by other users.

### BRIEF DESCRIPTION OF THE DRAWINGS

FIG. 1 is a block diagram of one embodiment of a cloud access system as disclosed.

FIG. 2 is a flowchart of one embodiment an operating method of a cloud access system as disclosed.

FIG. 3 is a schematic diagram of a friend schedule database utilized in the operating method of FIG. 2.

FIG. 4 is a detailed flowchart of the operating method of FIG. 2 showing synchronization of a shared data objects list.

### DETAILED DESCRIPTION

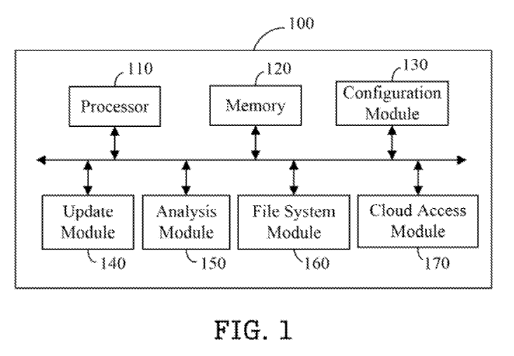

FIG. 1 is a block diagram of one embodiment of a cloud access system 100 providing connections between one or more users and one or more service providers. The term “service provider” as used herein refers to a third party that provides a cloud storage service and a social networking site application. The term “social networking site” as used herein refers to a website where users may access via a browser and interact with other users. The term “degree of activity” as used herein refers to a frequency of uploading shared data objects of a user of a social networking site. The cloud access system 100 comprises one or more processors 110, a memory 120, a configuration module 130, an update module 140, an analysis module 150, a file system module 160 and a cloud access module 170. The word “module”, as used herein, refers to a collection of software instructions and may be stored in any type of computer-readable storage medium, such as the memory 120. One or more software instructions of the modules 130˜170 may be executed by the processor 110. The processor 110 controls the overall functions of the cloud access system 100 and is in communication with the memory 120, the modules 130˜170. The processor 110 comprises a general-purpose processor, a specialized processor, a microprocessor, or the like that executes software instructions. In one embodiment, the processor 110 operates under control of logic embodied in firmware stored in the memory 120. The memory 120 comprises computer-readable storage media in the form of volatile and/or non-volatile memory such as random access memory (RAM) and read only memory (ROM). The configuration module 130 processes, for example, account information such as account identifiers, usernames, passwords, and view preferences. In one embodiment, the user interface accepts account information and review of preferences with one or more social networking sites. The account information identifies a user and permits access to social networking sites. The view preferences comprise data objects to be viewed, such as data objects shared by a particular group of a social networking site and/or shared data objects uploaded onto a social networking site during a particular time period.

The update module 140 polls shared data objects according to view preferences and sorts the shared data objects returned from the polling by attributes such as uploaded time or file name, or others. The analysis module 150 is operable to analyze degrees of activities of friends of the user of a social networking site and, accordingly, determine polling cycle of the update module 140. The file system module 160 is operable to process file operations received from the user interface. The cloud access module 170 is operable to provide unified application programming interfaces (APIs) for the configuration module 130, the update module 140 and the file system module 160 to access cloud services and translate the unified APIs to proprietary APIS of one or more supported service providers. Further details of these modules 130, 140, 150 and 160 follow. While an exemplary simplified architecture with one user accessing one service provider through the cloud access system 100 is used, it should be noted that the cloud access system 100 can provide one or more users access to one or more service providers concurrently.

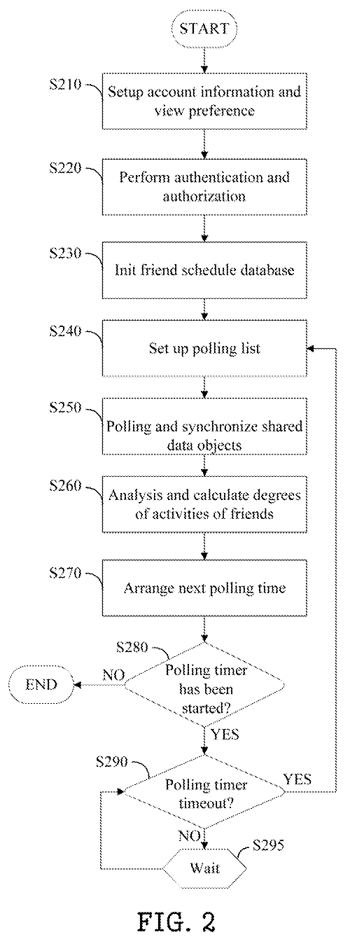

FIG. 2 is a flowchart of one embodiment an operating method of a cloud access system as disclosed. In step S210, the configuration module 130 receives account information and view preferences associated with a social networking site from the user interface and proceeds to step S220 to process authentication and authorization. In step S220, the configuration module 130 uses the received account information for user authentication and access authorization. If the user authentication is successful, the configuration module 130 stores the account information, view preferences and an access token obtained during the authentication in an account database and proceeds to step S230. If the user authentication fails, the configuration module 130 notifies the user of the authentication failure and requests re-entry of account information via the user interface. The access token records the access right of the social networking site. The account database is stored in the memory 120 and maintained by the configuration module 130 for the update module 140 and the file system module 160 to access. In step S230, the configuration module 130 uses the access token as a parameter to invoke the unified APIs provided by the cloud access module 170 for searching a friend list of the user on the social networking site. The configuration module 130 further uses the friend list information to initialize a friend schedule database 300.

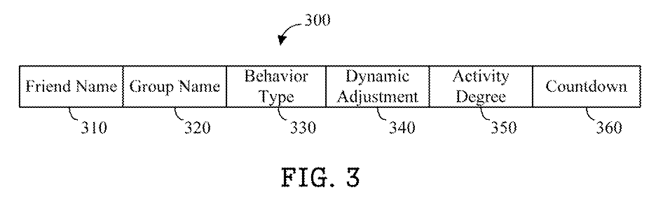

FIG. 3 is a schematic diagram of a friend schedule database utilized in the operating method of FIG. 2. The friend schedule database comprises friend name 310, group name 320, behavior type 330, dynamic adjustment 340, activity degree field 350 and countdown field 360. The friend name field 310 is an index of the friend schedule database 300 represents user name or account identifier of a friend and identifies the unique friend of the user on the social networking site. The group name field 320 is used to record the name of a group belongs to the friend. The data format of the behavior type field 330 is an integer, represents shared behavior of the friend. The data format of the dynamic adjustment field 340 is an integer, represents dynamic shared events of the friend. The data format of the activity degree field 350 is an integer, represents a degree of activity of the friend on the social networking site. The data format of the countdown field 360 is an integer, represents a value of a countdown timer for polling and synchronous updating of shared data objects of the friend. The friend schedule database 300 is initialized by the configuration module 130 with the friend list information retrieved in step S230. For example, as shown in the friend list, the user may have three friends on the social networking site, including two friends belonging to a “Family” group named “Kevin” and “Irene” separately and another belonging to a “Classmate” group, named “Jennifer”. When retrieving the friend list in step S230, the configuration module 130 initializes the friend schedule database 300 with three data rows. The first row of data comprises the friend name field 310 with “Kevin”, the group name field 320 with “Family” and value of the remaining fields are initialized to an integer value “0”. The second row of data comprises the friend name filed 310 with “Irene”, the group name field 320 with “Family” and value of the remaining fields are initialized to an integer value “0”. The last row of data comprises the friend name field 310 with “Jennifer”, the group name field 320 with “Classmate” and value of the remaining fields are initialized to an integer value “0”.

Returning now to FIG. 2, in step S240, the update module 140 retrieves data rows the values of which comply with view preferences and the value of the countdown field 360 is less than or equal to “0” from the friend schedule database 300 and establishes a polling list. The update module 140 further reads account information of the user from the account database stored in the memory 120 and adds the account information to the polling list. For example, if the account information is set with a user name “Karen” and view preferences with a group named “Family”, upon implementation of step S240, the update module 140 retrieves two friends named “Kevin” and “Irene” separately to establish the polling list and finally adds a data with user name “Karen” into the polling list. After step S240, the update module establishes the polling list with the user and friends of the user on the social networking site according to view preferences. In one embodiment, in order to synchronize with the social networking site, the update module 140 invokes the unified APIs provided by the cloud access module 170 to confirm members of the group set in view preferences and compares the members with the friend schedule database 300 before executing step S240. After comparison, the update module 140 modifies the friend schedule database 300 according to the comparing result.

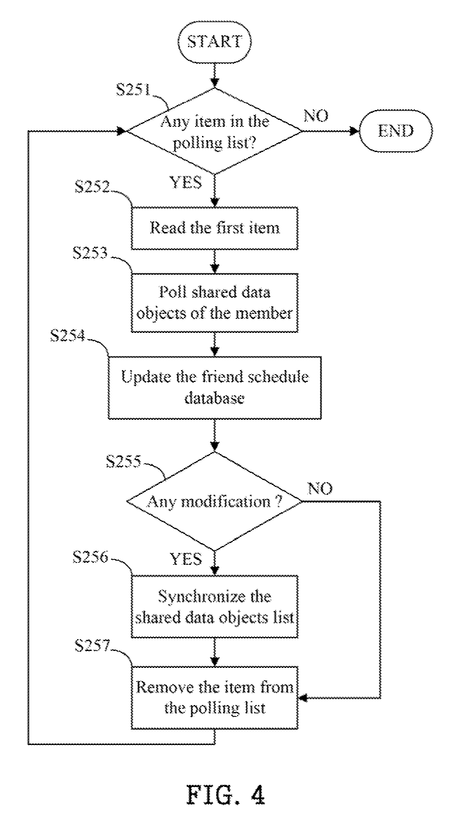

In step S250, the update module 140 invokes the unified APIs provided by the cloud access module 170 to poll shared data objects uploaded by members of the social networking site recorded in the polling list. The update module 140 further synchronizes the shared data objects list according to the polling result. FIG. 4 is a detailed flowchart of the operating method of FIG. 2 showing synchronization of a shared data objects list.

In step S251, the update module 140 determines whether there is any item in the polling list. If the polling list comprises at least one item, the update module 140 proceeds to step S252 to retrieve the name in the first item of the polling list, otherwise, the synchronization processing is finished.

In step S253, the update module 140 invokes the unified APIs provided by the cloud access module 170 with the name of the member to poll shared data objects uploaded by the member and dynamic information of the member on the social networking site. The shared data objects comprises documents, albums, photos, videos, and others. In step S254, the update module 140 uses the shared data object information and dynamic information of the member to update the behavior type field 330 and the dynamic adjustment field 340 of the corresponding data row of the friend schedule database. In one embodiment, the behavior type field 330 is updated according to sharing behavior type of the polling result. For example, if the member shares no data object, the value of the behavior type field 330 is “1”. If the member uploads shared data objects but has not updated in the past month, the value of the behavior type field 330 is “3”. If the member does upload and update shared data objects in past one month, the value of the behavior type field 330 is “7”. In other words, the value of the behavior type field 330 is related to frequencies of uploading and/or updating behaviors. In one embodiment, the dynamic adjustment field 340 is used to count the dynamic sharing events of the member. For example, if the member has any updating of shared data objects of the polling result, the value of the dynamic adjustment field 340 is increased by one. If the member has no updating of the polling result, the value of the dynamic adjustment 340 is decreased by one. That is, if the member updates shared data objects more frequently, the value of the dynamic adjustment 340 increases.

In step S255, the update module 140 determines whether shared data objects have any modification, comprises shared data objects addition and/or deletion. If there is no modification, step S257 is implemented, otherwise, step S256 is implemented. In step S256, the update module 140 reads the time period setting of the view preferences from the account database and synchronizes shared data objects modified times of which comply with the time period to the shared data objects list. If the modification is deletion, the update module 140 removes corresponding shared data objects from the list. If the modification is addition, the update module renames file names of the shared data objects as time related format, such as “YYYYMMDD_<user name>_<original file name>”, and adds new shared data objects into the list. In one embodiment, YYYYMMDD represents the uploaded time of a shared data object, wherein YYYY represents AD, MM represents month and DD represents date. In one embodiment, the <user_name> represents the owner of a shared data object. In one embodiment, the <original_file_name> represents original file name of a shared data object. In step S257, the update module 140 removes the first item from the polling list and step S251 is implemented, in which the next item, if existing in the polling list, is processed.

Returning now to FIG. 2, when the update module 140 finishes synchronizing the shared data objects list, the analysis module 150 step S260 is implemented, in which analysis module 150 reads each row of data in the friend schedule database 300, analyzes and calculates a degree of activity of each friend and records the value of the degree of activity in the activity degree field 350. In one embodiment, the value of the degree of activity is the sum of the behavior type field 330 and the dynamic adjustment field 340. The value of the degree of activity corresponds to whether the user is more active, that is, the frequency of shared data objects of the user updating on the social networking site. In step S270, the analysis module 150 sequentially reads the value of the activity degree field 350 of each row, determines an initial value of a countdown timer for synchronizing shared data objects of a friend based on the value of the degree of activity and stores the initial value in the countdown field 360. In one embodiment, the value of the activity degree field 350 and the initial value of the countdown timer have an inverse relationship, for example, higher value of the activity degree field 350 corresponds to lower initial value of the countdown timer. When the analysis module 150 finishes updating the countdown field 360 of each row in the friend schedule database 300, a minimum value is selected there from and a polling timer initialized to count the minimum value.

In step S280, the processor 110 first determines whether the polling timer is activated. If the polling timer is activated, step S290 is implemented, otherwise, the processor 110 finishes all processing. In step S290, the processor 110 determines whether the polling timer is timed out. If the polling timer timed out, the processor 110 reads the countdown field 360 of each row in the friend schedule database 300 from the memory 120, minus the value of the countdown field 360 by the value of the polling timer, updates the countdown field 360 and step S240 is implemented. If the polling timer does not time out, the processor 110 waits in step S295 and step S290 is implemented.

The file system module 160 is operable to receive and process file operations from the user interface. The file system module 160 divides file operations into two types, such as retrieve list type and access data type. If a file operation is the retrieve list type, such as getdir( ), getattr( ) statfs( ), etc., the file system module 160 responds to the file operation with the shared data objects list. If a file operation is the access data type, such as open( ) read( ) etc., the file system module 160 invokes the unified APIs provided by the cloud access module 170 to access shared data objects stored remotely on the social networking site.

In conclusion, the cloud access system 100 allows setup of view preferences for displaying data objects shared by friends on the social networking site and translates the shared data objects to serve retrieve list file operations not only reducing loading of the processor 110 but also unnecessary waste of network bandwidth resources.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud access system, comprising:
one or more processors;
a memory; and
one or more programs stored in the memory and configured to be executed by the one or more processors, the one or more programs comprising:
a configuration module operable to receive a view preference from a user of a social networking site, wherein the view preference comprising at least one group name of social networking site and at least one time period;
a updating module operable to poll shared data objects of the user and friends of the user of the social networking site that comply with the view preference and sort the shared data objects returned from the polling by uploaded time into a shared data objects list stored in the memory; and
a analysis module operable to analyze degrees of activities of the friends that comply with the view preference to determine a polling cycle of the updating module.

2. The cloud access system of claim 1, wherein the one or more programs further comprise:
a cloud access module operable to invoke translation between one or more unified application programming interfaces and application programming interfaces of the one or more social networking site.

3. The cloud access system of claim 1, wherein the one or more programs further comprise:
a file system module operable to receive file operations for the user and responding file operations with the shared data objects list if the file operations are retrieve list file operations.

4. The cloud access system of claim 3, wherein if the file operations are access data file operations, the file system module invokes the one or more unified application programming interfaces provided by the cloud access module to access shared data objects stored remotely on the social networking sites.

5. The cloud access system of claim 4, wherein the degrees of activities are calculated from the dynamic sharing information returned from the polling made by the update module.

6. A method for operating a cloud access system, comprising:
receiving a view preference from a user of a social networking site, wherein the view preference comprising at least one group name of the social networking site and at least one time period;
polling shared data objects of the user and friends of the user of the social networking site that comply with the view preference and sorting shared data objects by uploaded time into a shared data objects list stored in the memory; and
analyzing degrees of activities of the friends that comply with the view preference to determine a polling cycle.

7. The method for operating the cloud access system of claim 6, further comprises:
providing invoking translation between one or more unified application programming interfaces and application programming interfaces of the one or more social networking site.

8. The method for operating the cloud access system of claim 6, further comprises:
receiving file operations for the user and responding file operations with the shared data objects list if the file operations are retrieve list file operations.

9. The method for operating the cloud access system of claim 8, wherein if the file operations are access data file operations, invoking the one or more unified application programming interfaces provided by the cloud access module to access shared data objects stored remotely on the social networking sites.

10. The method for operating the cloud access system of claim 9, wherein the degrees of activities are calculated from the dynamic sharing information returned from the polling.
